(19) United States
(12) Patent Application Publication
(10) Pub. No.: US 2009/0287994 A1
(43) Pub. Date: Nov. 19, 2009

(54) DOCUMENT PROCESSING DEVICE AND DOCUMENT PROCESSING METHOD

(75) Inventor: Takahiko Ichino, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi (JP)

(21) Appl. No.: 12/092,168

(22) PCT Filed: Oct. 31, 2006
(86) PCT No.: PCT/JP2006/321798

§ 371 Date: Apr. 30, 2008

(30) Foreign Application Priority Data
Oct. 31, 2005 (JP) 2005-316270
Oct. 31, 2005 (JP) 2005-317826

(51) Int. Cl. G06F 17/00

(52) U.S. Cl. 715/234

(57) ABSTRACT

A technology is provided which presents a summary of a document in an easy-to-understand manner. An acquisition unit of a document processing apparatus acquires a document described in a markup language. A condition setting unit sets a condition for display of an outline of a document for each tag set of the markup language. A condition memory unit stores the condition for display thus set. An outline view creating unit reads, when a request for displaying an outline of a document acquired by the acquisition unit is accepted, from the condition memory unit the condition for display corresponding to a tag set included in the document, and creates a display of an outline of the document, based upon the condition.

### TECHNICAL FIELD

The present invention relates to a document processing technology and, more particularly, to a document processing apparatus and a document processing method for processing documents described in a markup language.

### BACKGROUND ART

XML is viewed as a format suitable for exchanging data with others over a network, for example. Applications are being developed for creating, displaying, and editing an XML document (see, for example, patent document No. 1). An XML document is drafted based upon a vocabulary (tag set) defined by, for example, a document type definition.

[Patent document No. 1] JP 2001-290804

### DISCLOSURE OF THE INVENTION

### Problem to be Solved by the Invention

As the size of a document grows, it becomes difficult to understand the entirety of the document. A technology capable of providing users with an environment in which users can edit a document while understanding its structure is called for.

In this background, a general purpose of the present invention is to provide a technology for presenting a summary of a document in an easy-to-understand manner.

### Means to Solve the Problem

One embodiment of the present invention relates to a document processing apparatus.

The condition for display may include a condition which specifies items to be displayed when displaying an outline of the document, and the creating unit extracts the items to be displayed from the document and creates a display of an outline by hierarchizing the items in accordance with the hierarchy of the document.

The condition for display may further include a condition which specifies an item to be used as a delimiter for the levels of the items to be displayed when displaying an outline of the document, and the creating unit may extract the delimiter items from the document, and create a display of an outline by hierarchizing the items to be displayed thus extracted, in accordance with the hierarchy of the delimiter items in the document. The creating unit may create a display of an outline by regarding those items to be displayed, located in the hierarchy between one delimiter item and another delimiter item at a lower level, as belonging to the same level.

The condition for display may include a condition which specifies items to be displayed when displaying an outline of a document, and a condition which specifies a level of the items in the outline displayed, and the creating unit may extract from the document the items to be displayed, and create a display of an outline by identifying the levels of the items thus extracted in the outline displayed and hierarchizing the items in accordance with the levels thus identified.

Another embodiment of the present invention relates to a document processing method. The document processing method comprises acquiring a document described in a markup language; setting a condition for display of an outline of a document for each tag set of the markup language; storing the condition for display in a memory unit; and reading, when a request for displaying an outline of the document thus acquired is accepted, from the memory unit the condition for display corresponding to a tag set included in the document, and creating a display of an outline of the document, based upon the condition.

Optional combinations of the aforementioned constituting elements, and implementations of the invention in the form of methods, apparatuses, systems, and the like may also be practiced as additional modes of the present invention.

### ADVANTAGE OF THE PRESENT INVENTION

The present invention provides a technology for presenting a summary of a document in an easy-to-understand manner.

### BRIEF DESCRIPTION OF THE DRAWINGS

FIG. 1 is a diagram which shows a configuration of a document processing apparatus according to the base technology;

FIG. 2 is a diagram which shows an example of an XML document which is a processing target;

FIG. 3 is a diagram which shows an example in which the XML document shown in FIG. 2 is mapped to a table described in HTML;

FIG. 4A is a diagram which shows an example of a definition file used for mapping the XML document shown in FIG. 2 to the table shown in FIG. 3;

FIG. 4B is a diagram which shows an example of a definition file used for mapping the XML document shown in FIG. 2 to the table shown in FIG. 3;

FIG. 5 is a diagram which shows an example of a screen on which the XML document, which has been described in a marks managing vocabulary and which is shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11 shows the structure of a document processing apparatus according to an embodiment;

FIG. 12 shows an example of a dialog screen presented by a condition setting unit;

FIGS. 13A and 13A show examples of dialog screens presented by the condition setting unit;

FIG. 14 shows an example of a dialog screen when an “add” or “edit” button is clicked in the dialog screen of FIG. 13A;

FIG. 15 shows an example of a dialog screen when an “add” or “edit” button is clicked in the dialog screen of FIG. 13B;

FIG. 16 shows an example of a dialog screen presented by the condition setting unit;

FIG. 17 shows an example of a condition for display set by the condition setting unit;

FIG. 18 shows an example of an XML document described in the XHTML vocabulary;

FIG. 19 is an example of a display screen displaying an outline of the XML document shown in FIG. 18 based upon the condition for display shown in FIG. 17;

FIG. 20 shows another example of a condition for display set by the condition setting unit;

FIG. 21 shows an exemplary XML document described in the XHTML vocabulary; and

FIG. 22 shows an example of displaying an outline of the XML document shown in FIG. 21, based upon the condition for display shown in FIG. 20.

### DESCRIPTION OF THE REFERENCE NUMERALS

20 document processing apparatus, 22 main control unit, 24 editing unit, 29 acquisition unit, 30 DOM unit, 32 DOM provider, 34 DOM builder, 36 output unit, 40 CSS unit, 42 CSS parser, 44 CSS provider, 46 rendering unit, 50 HTML unit, 52, 62 control unit, 54, 64 editing unit, 56, 66 display unit, 60 SVG unit, 70 outline display unit, 71 condition setting unit, 72 condition memory unit, 73 outline view creating unit, 80 VC unit, 82 mapping unit, 84 definition file acquisition unit, 86 definition file creating unit, 100 document processing apparatus

### BEST MODE FOR CARRYING OUT THE INVENTION

### Base Technology

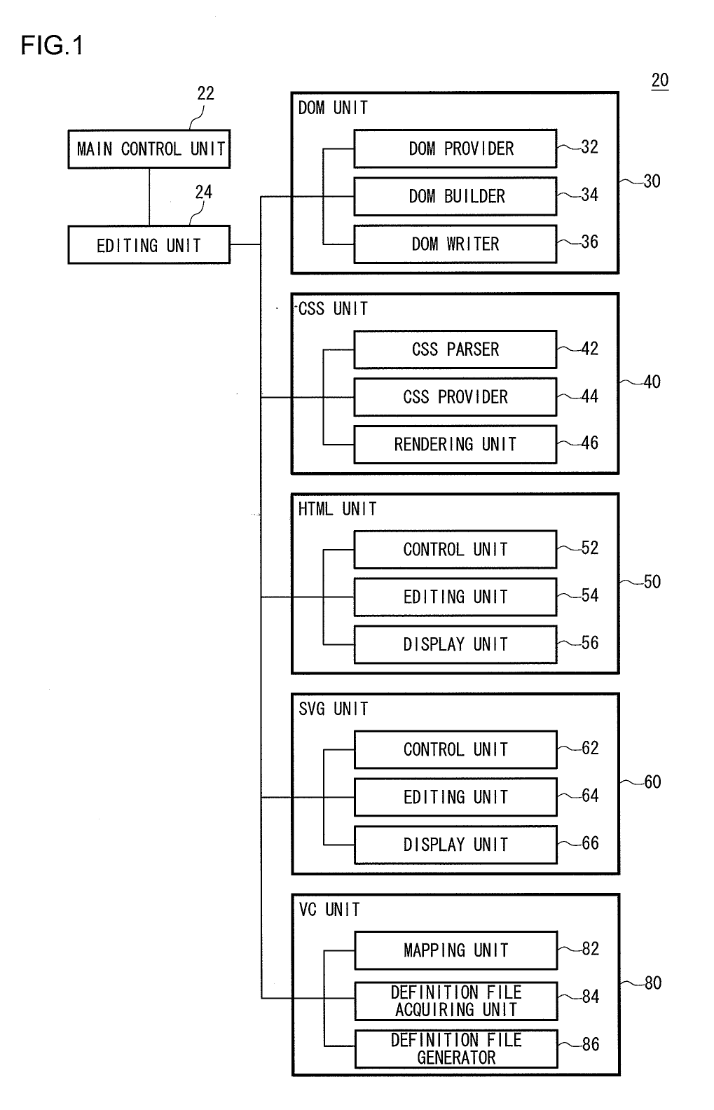

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

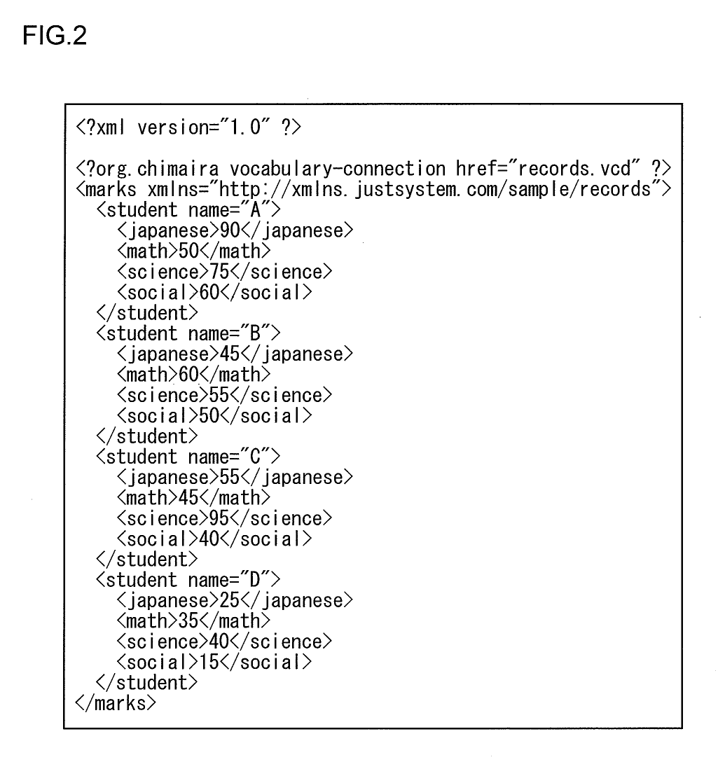

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

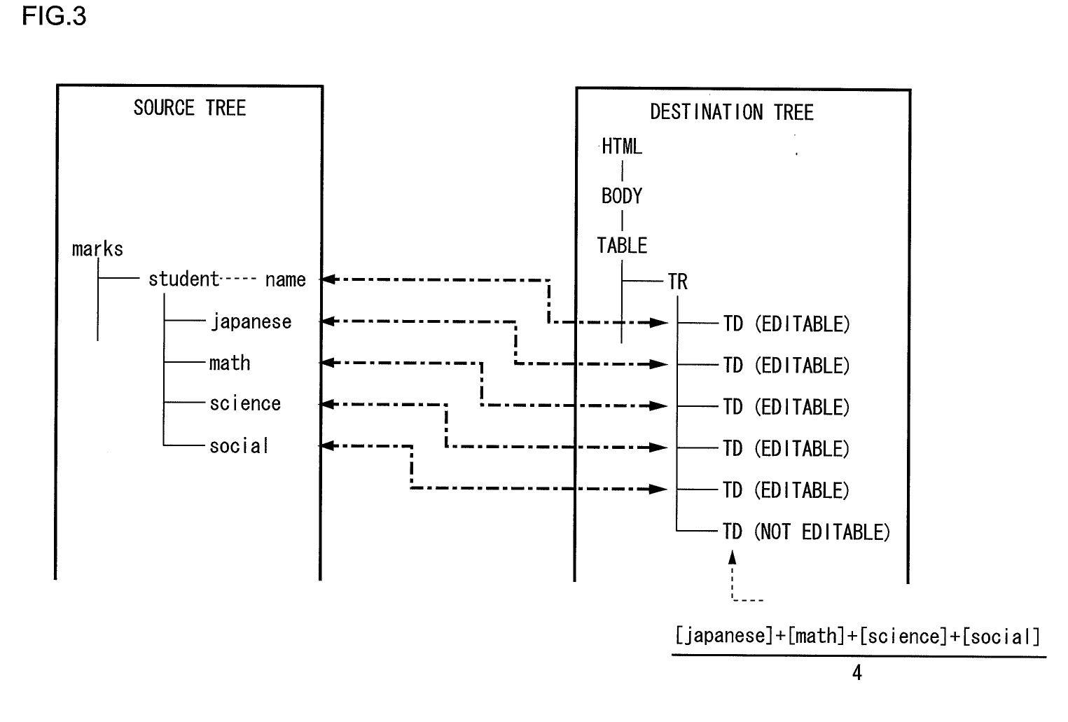

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

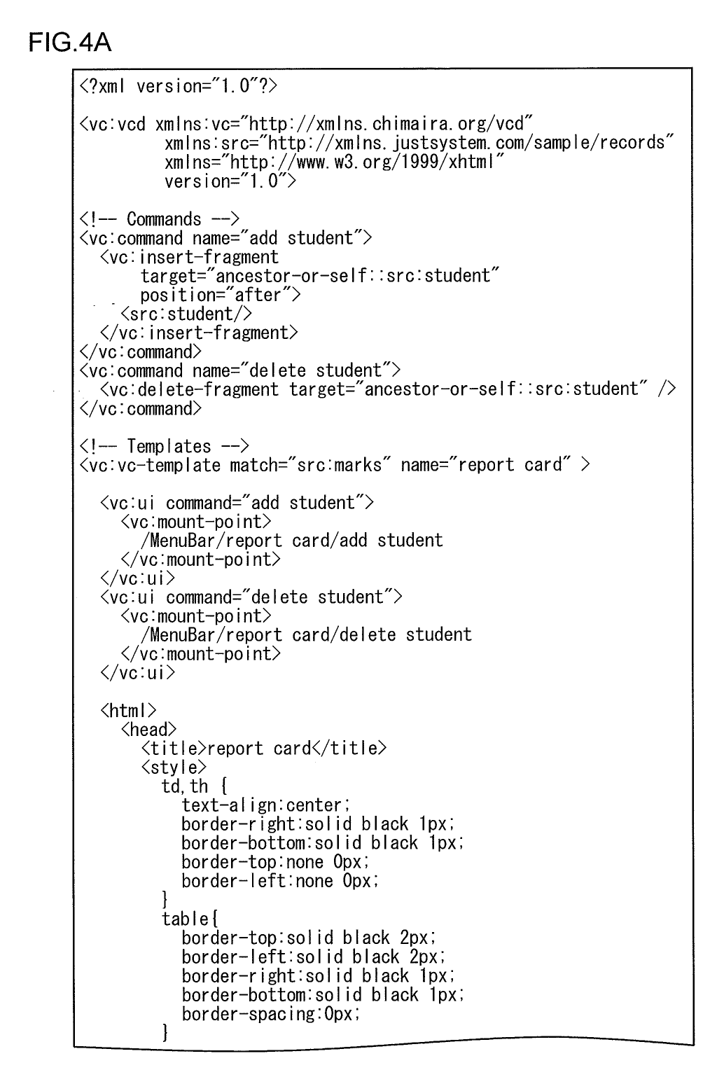

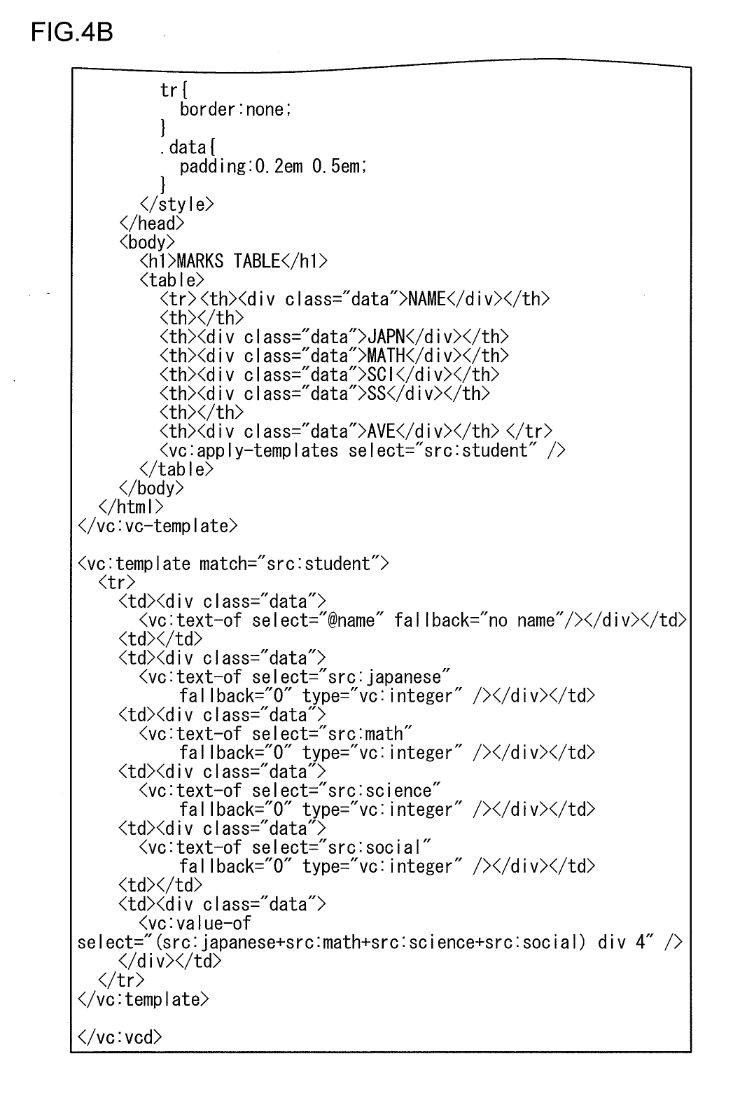

FIG. 4A and FIG. 4B illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4A and FIG. 4B, “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

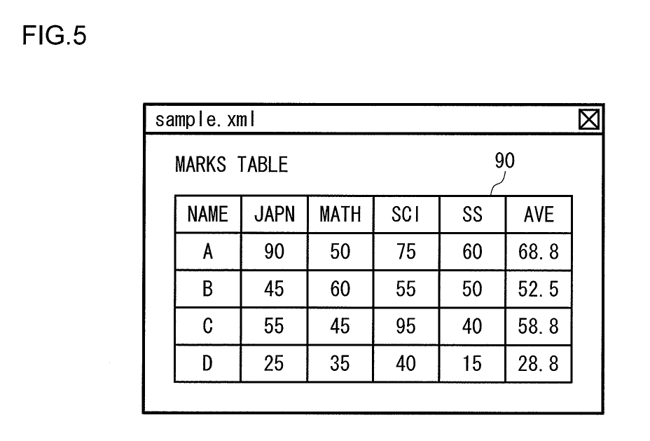

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4A and FIG. 4B. When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

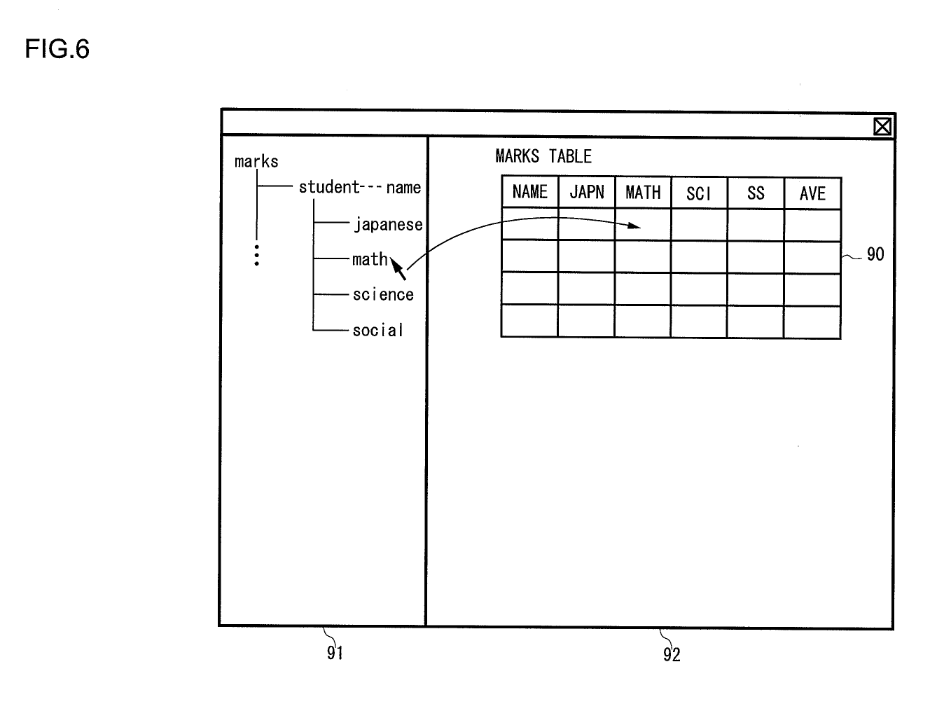

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

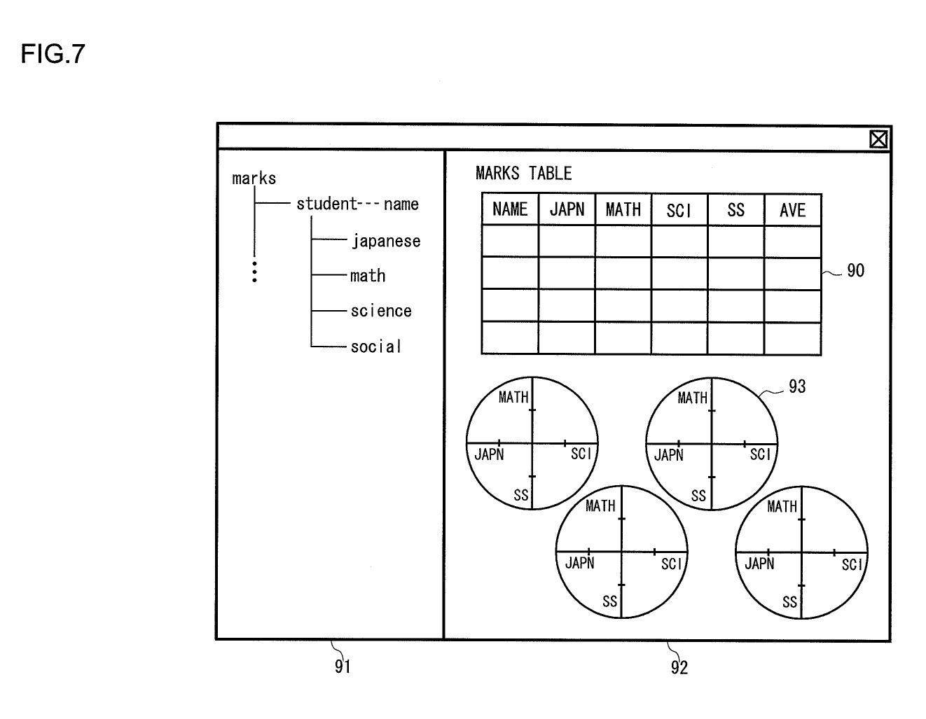

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

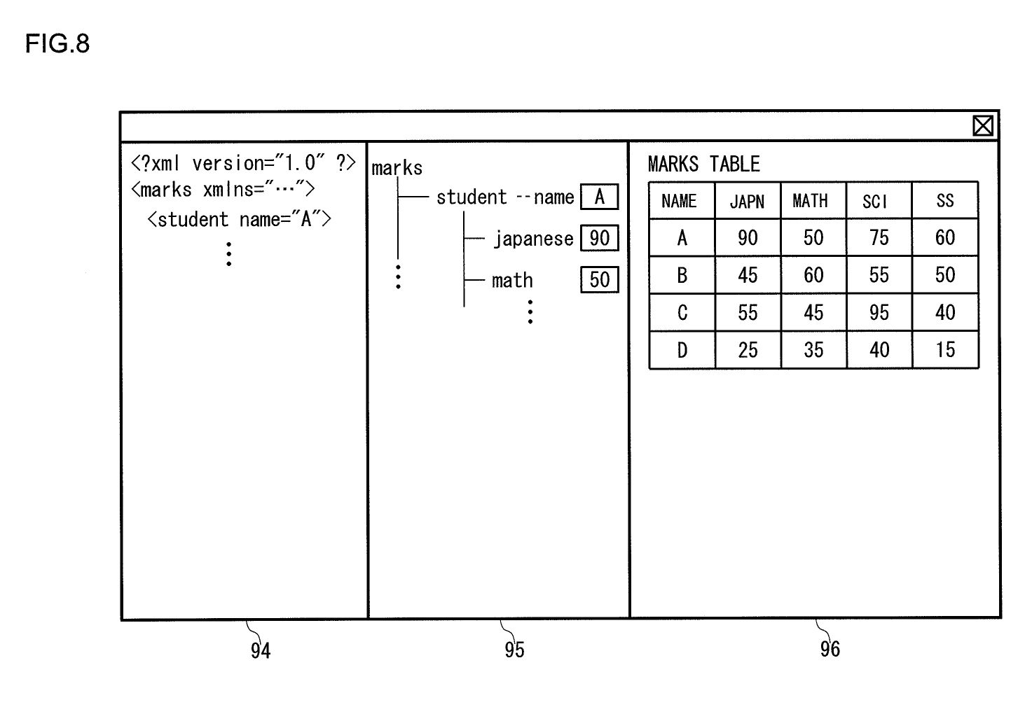

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

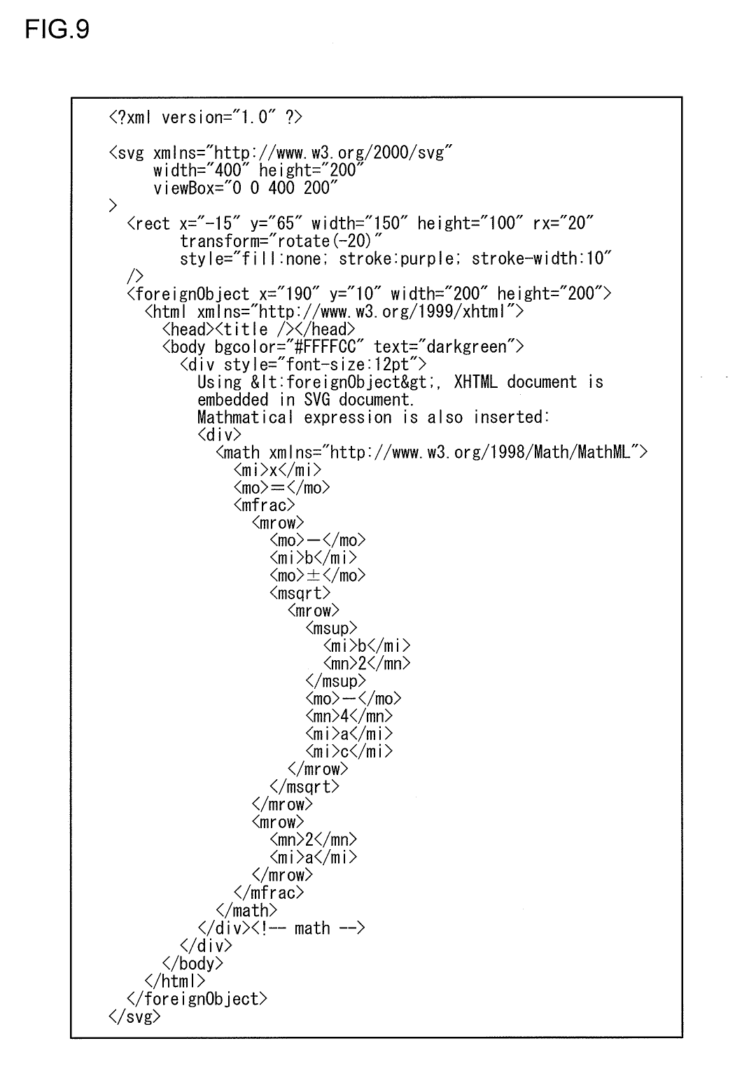

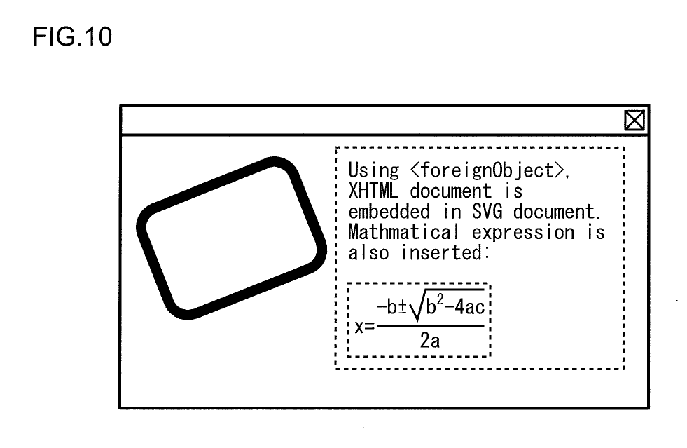

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

The embodiment provides a technology of extracting a specific element or attribute from an XML document and displaying an outline of the document.

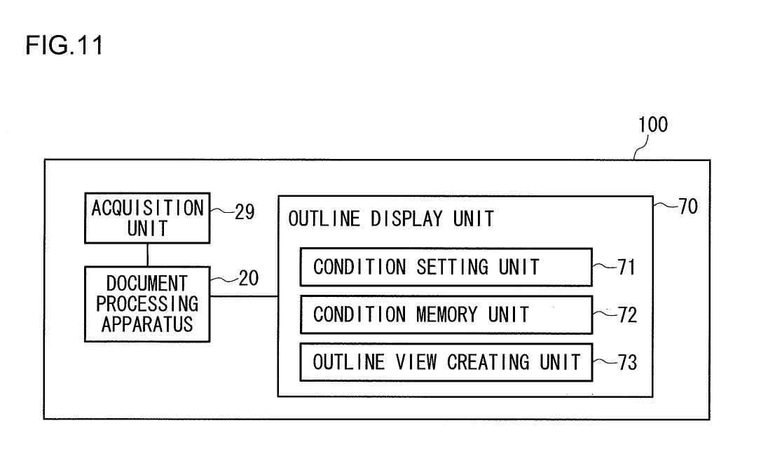

FIG. 11 shows the structure of a document processing apparatus 100 according to the embodiment. The document processing apparatus 100 comprises an acquisition unit 29 and an outline display unit 70 in addition to the structure of the document processor apparatus 20 described in the base technology. The acquisition unit 29 acquires a document described in a markup language such as XML. The outline display unit 70 displays a summary of the structure of the acquired document. The outline display unit 70 comprises a condition setting unit 71 for setting a condition for displaying the outline of the document, a condition memory unit 72 for storing the condition for display thus set, and an outline view creating unit 73 for creating a screen displaying the outline of the document based upon the condition for display thus set. The blocks as shown may be implemented by hardware components such as a CPU and a memory of a computer, and by software such as a program or the like loaded into the memory. FIG. 11 depicts functional blocks implemented by the cooperation of hardware and software. Therefore, it will be obvious to those skilled in the art that the functional blocks may be implemented in a variety of manners by hardware only, software only, or a combination thereof.

The condition setting unit 71 sets a condition for displaying an outline for each tag set or vocabulary. The term “tag set” refers to a set of tags for marking up a document and is often used synonymously with “vocabulary”. However, a “tag set” may be a subset of a “vocabulary” or includes tags from a plurality of vocabularies.

The condition setting unit 71 may automatically set a condition for displaying an outline based upon the schema of the vocabulary. Alternatively, a user's input of a display condition may be accepted. In the case of automatically creating a condition for displaying an outline from a schema, the condition setting unit 71 learns the hierarchy of tags based upon the schema. For example, the unit 71 searches from the root elements to identify those elements that occur in parallel a plurality of times as the search goes down the hierarchy, and sets the elements thus identified as elements to be extracted in displaying an outline.

In the case of accepting a condition for display from a user, the condition setting unit 71 presents a dialog screen for the setting and accepts from the user a namespace URI of a vocabulary or a tag set for which the condition for display is set, the element name of a root element, the type of elements or attributes to be extracted, and the display format such as font size and color.

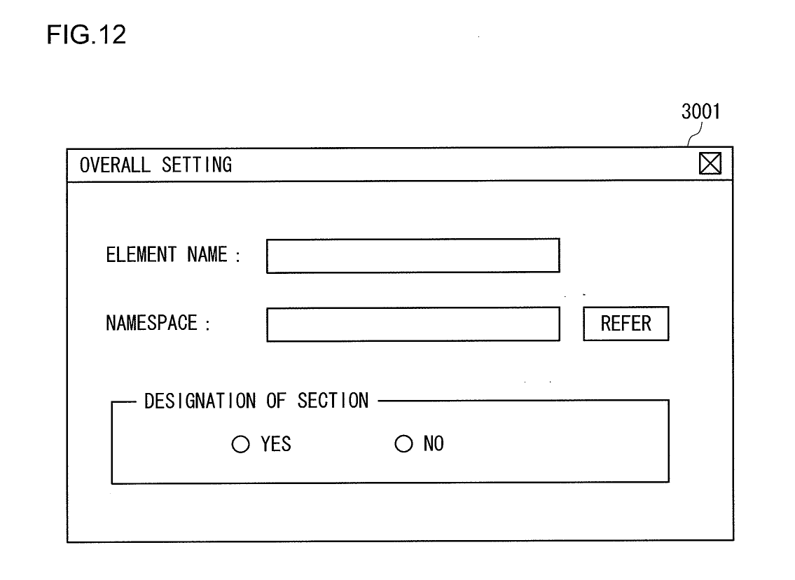

FIG. 12 shows an example of a dialog screen presented by the condition setting unit 71. A dialog screen 3001 is a screen for accepting an overall setting related to display of an outline. The dialog screen 3001 accepts the namespace of a vocabulary for which a condition for displaying an outline is set, a root element, and indication of whether a section is designated. Designation of a section will be described in detail below. When a section is designated, an outline is displayed in which the hierarchy of those elements in the document hierarchy designated as section items is reflected. In the absence of designation of a section, an outline with a hierarchy designated as the condition for display is displayed.

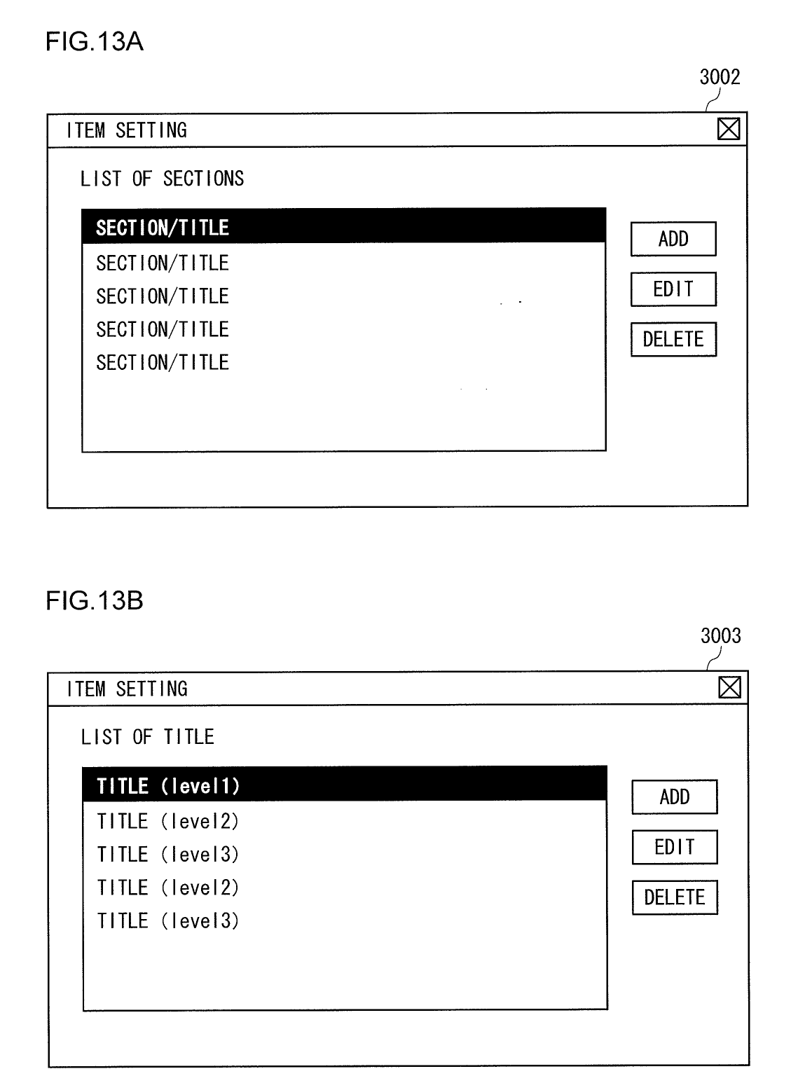

FIGS. 13A and 13A show examples of dialog screens presented by the condition setting unit 71. A dialog screen 3002 shown in FIG. 13A and a dialog screen 3003 shown in FIG. 13A are screens for accepting the setting of items displayed in an outline. When designation of a section is indicated as being valid in the dialog screen 3001, the dialog screen 3002 displays a list of pairs of sections and titles already set. When designation of a section is indicated as being not valid in the dialog screen 3001, the dialog screen 3003 displays a list of pairs of titles and levels already set. In each of the screens, an add/edit dialog screen is presented when the “add” or “edit” button is clicked.

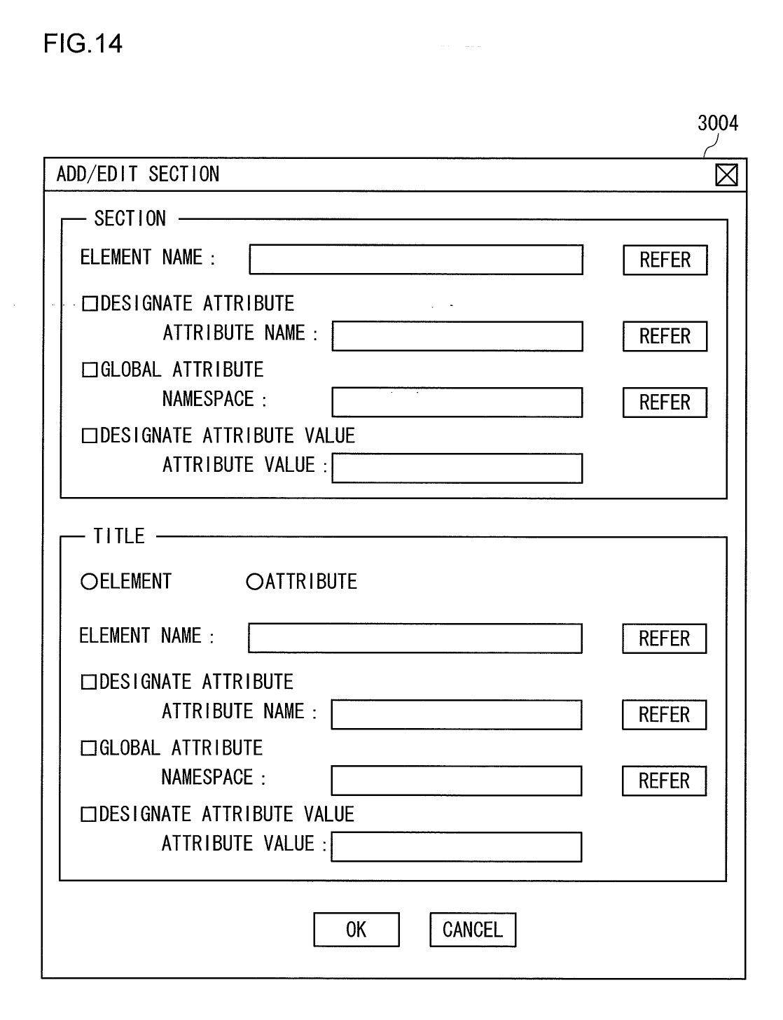

FIG. 14 shows an example of a dialog screen when the “add” or “edit” button is clicked in the dialog screen 3002 of FIG. 13A. A dialog screen 3004 is a screen for accepting addition or editing of a section and a title. A section is an item that represents a delimiter in the hierarchy of elements (tags) in a document. A title is an item displayed in the outline. The dialog screen 3004 accepts the element name of a section and the element name of a title. An attribute, a global attribute, or an attribute value may be designated as a section or a title. Clicking the “refer” button in the dialog screen 3004 will display candidates for element names, attribute names, and global attributes that can be designated. The candidates may be presented by referring to the elements or attributes included in a document currently edited or by referring to the schema or instance of the vocabulary for which the condition for display is set.

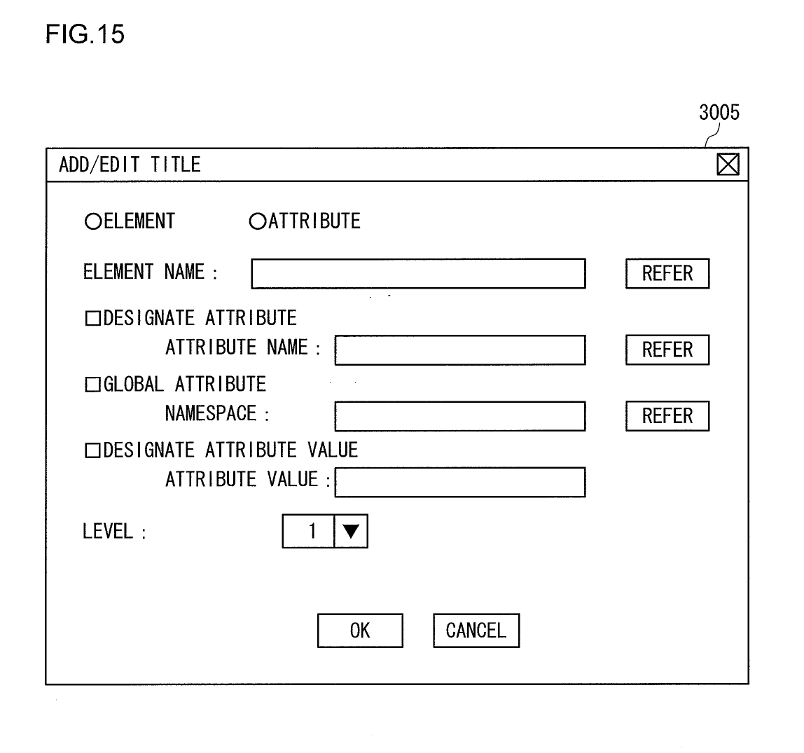

FIG. 15 shows an example of a dialog screen presented when the “add” or “edit” button is clicked in the dialog screen 3003 of FIG. 13B. A dialog screen 3005 is a screen for accepting a title and a level. A title is an item displayed in the outline. When an outline is displayed using a plurality of titles, the levels of the titles in the outline can be designated.

Thus, the condition for display may be so as to create a display of an outline reflecting the hierarchy of a document. Alternatively, a hierarchy different from the hierarchy of a document may be defined. In the former case, elements or attributes may be defined as title items to be displayed, for example. The items thus defined are extracted from the document and displayed hierarchically in accordance with the hierarchy of the document. In this case, the hierarchy is determined based upon the section items. That is, title items, located at levels between a given section item and another section item below the given item in the hierarchy, are considered to be at the same level even if the title items are located at different levels in the document. In the latter case, even if the document is not organized hierarchically, a hierarchical display of an outline is achieved by designating a level for title items such as elements and attributes.

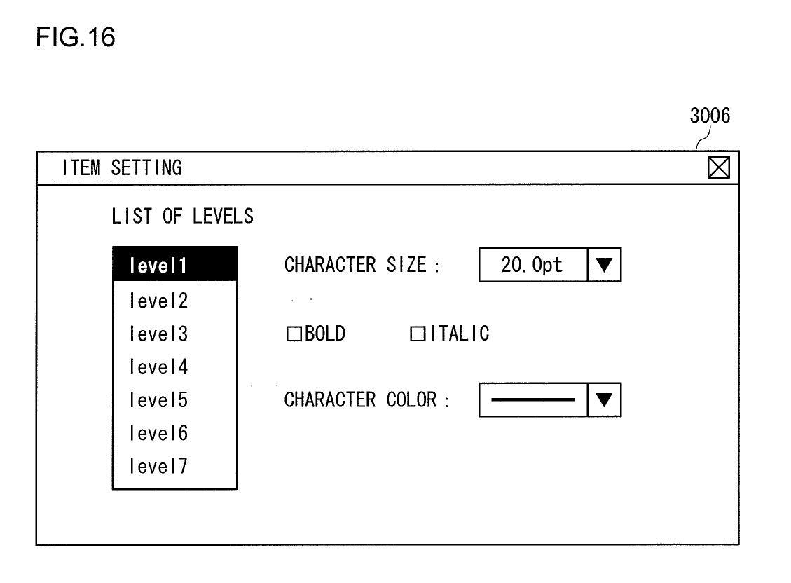

FIG. 16 shows an example of a dialog screen presented by the condition setting unit 71. A dialog screen 3006 is a screen for accepting a display style for each level in an outline displayed. Character size, character formatting (bold, italic), and character color may be designated as the style of displaying titles at the respective levels.

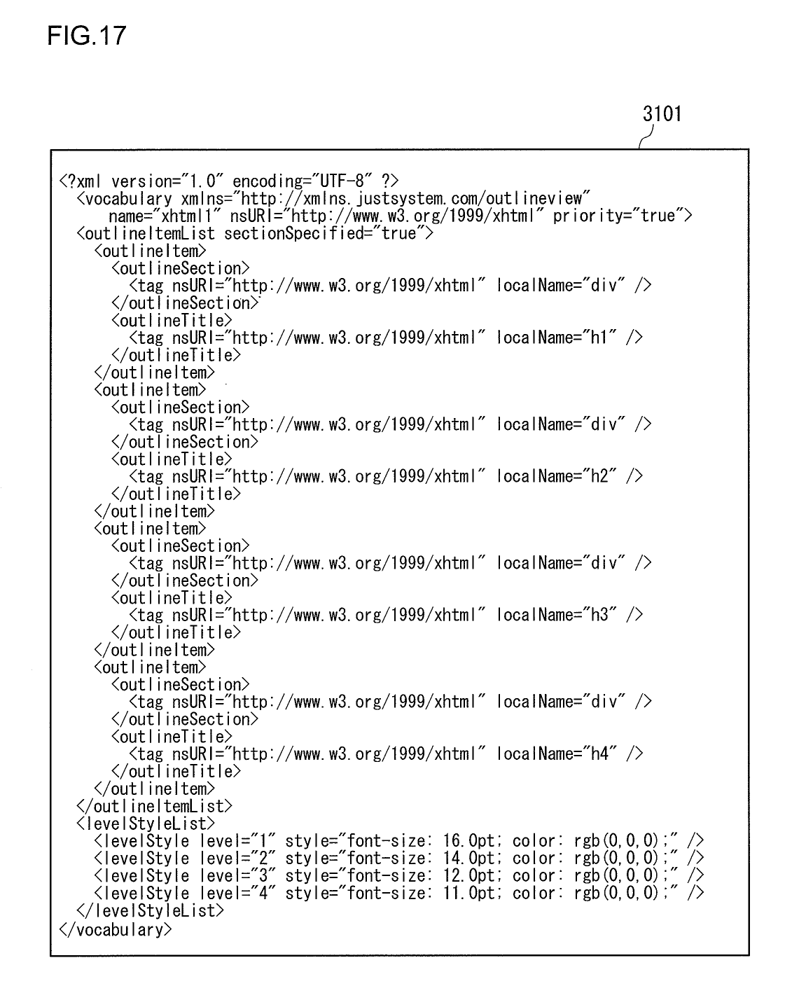

FIG. 17 shows an example of a condition for display set by the condition setting unit 71. In this embodiment, the condition for display is stored in the condition memory unit 72 in the XML format. A setting file 3101 of FIG. 17 stores a condition for displaying an outline of a document described in the XHTML vocabulary. An element “div” is designated as a section item in the setting file 3101, and elements “h1”, “h2”, “h3”, and “h4” are designated as title items. Accordingly, the element “div” represents a delimiter for the levels of title items in the outline displayed.

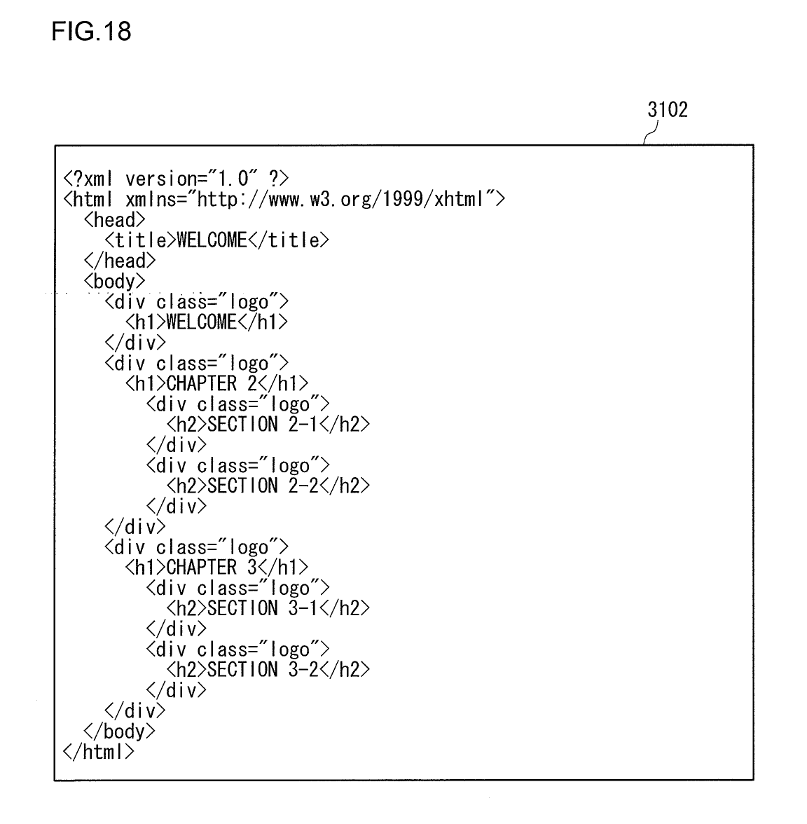

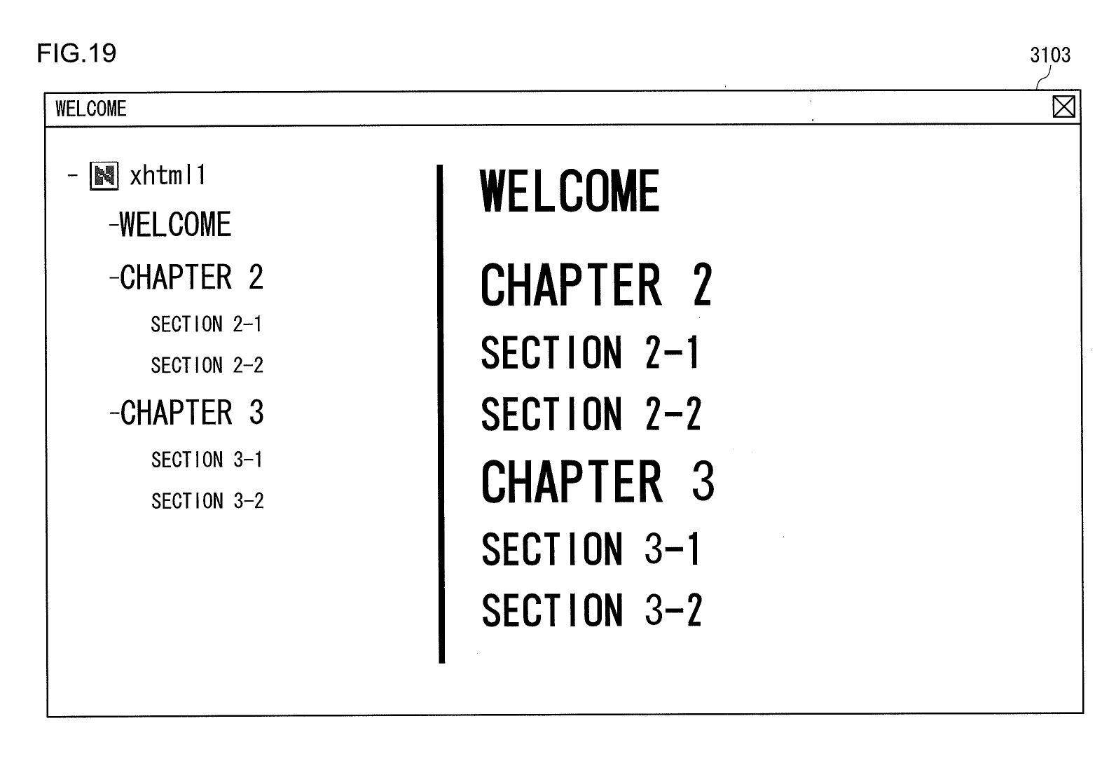

FIG. 18 shows an example of an XML document 3102 described in the XHTML vocabulary. FIG. 19 is an example of a display screen 3103 displaying an outline of the XML document 3102 shown in FIG. 18, based upon the condition for display shown in FIG. 17. The display screen 3103 is divided into two display areas. On the left side, an outline of the document is displayed. On the right side, the body of the document is displayed. The outline view creating unit 73 reads the applicable condition for display from the condition memory unit 72, based upon the namespace for the root element of the XML document to be displayed. In this case, the display condition in which sections are designated is set. Therefore, the outline view creating unit 73 retrieves designated title items from the document, and builds a hierarchy of the title items thus extracted using section items as delimiters for the levels. In the illustrated example, the element “div” is designated as a section item. Therefore, the title items are hierarchized and displayed in accordance with the hierarchy of the element “div” in the document. In case an element or an attribute is set as a title item, the value of a text node of the element of the attribute may be displayed as a title item. Alternatively, the name of the element or the attribute may be displayed. If an attribute value is set as a title item, the attribute value may be displayed.

In an outline view, a title item that encompasses another title item in a lower level may be provided with UI such as an icon for designating display/non-display of the lower level. By clicking the icon, an expanded or collapsed view of the lower level can be displayed. Double-clicking a title item displayed in an outline view may initiate a jump to a relevant part of the body of the document. An element value, an attribute value, or the like displayed as a title item in an outline view may be editable. The hierarchy of the document may be editable in an outline view. For example, the hierarchy of the body of the document may be changed by dragging and dropping a title item.

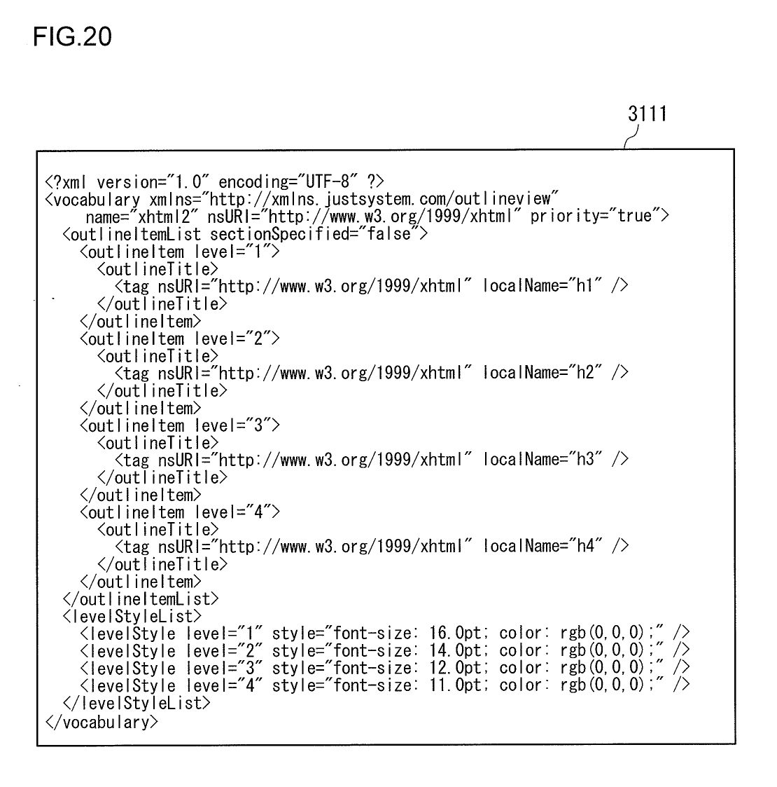

FIG. 20 shows another example of a condition for display set by the condition setting unit 71. A setting file 3111 of FIG. 20 stores a condition for displaying an outline of a document described in the XHTML vocabulary. In the setting file 3111, sections are not designated, and the title items and the levels are stored in association with each other. For example, level “1”, the top level in the hierarchy, is designated for an element “h1”, level “2” is designated for an element “h2”, level “3” is designated for an element “h3”, and level “4” is designated for an element “h4”.

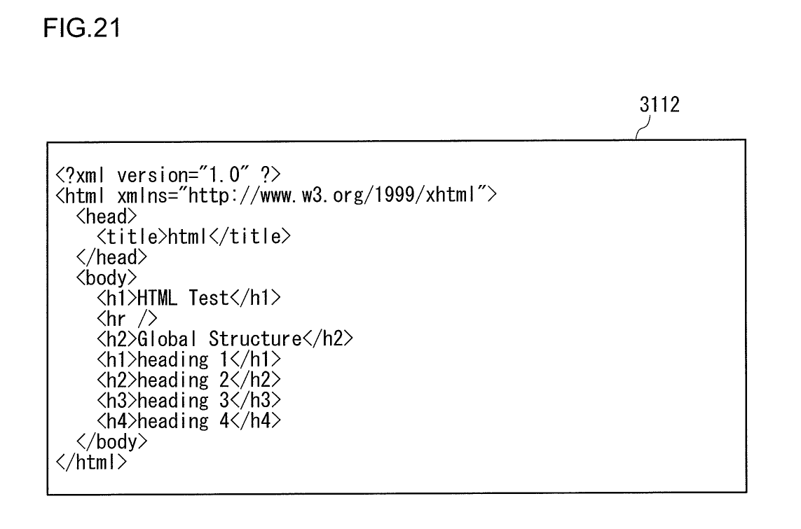

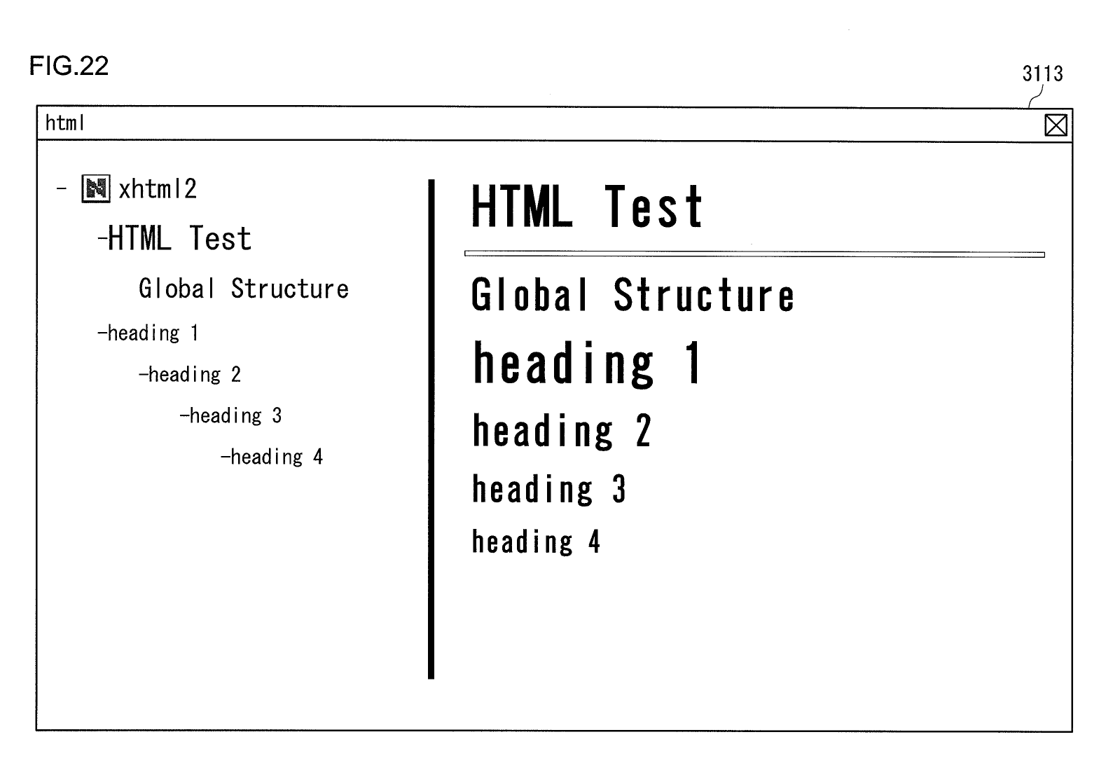

FIG. 21 shows an exemplary XML document 3112 described in the XHTML vocabulary. FIG. 22 shows an example of a display screen 3113 displaying an outline of the XML document 3112 shown in FIG. 21, based upon the condition for display shown in FIG. 20. The outline view creating unit 73 extracts designated title items from the document, hierarchizes the items based upon the level designated for the respective title items, and displays the items accordingly. The element “h1”, the element “h2”, the element “h3”, and the element “h4” all belong to the same level in the hierarchy of the XML document 3112. However, the elements are hierarchized according to the levels designated in the setting file 3111 and are displayed accordingly.

If a document includes a plurality of namespaces, the document is divided into a plurality of areas based upon the namespaces. An outline view is created as described above based upon the namespaces of the respective areas. If there is an element belonging to a namespace for which the condition for display is not set, an icon may be displayed to indicate that the namespace is unknown, or a source of the document may be displayed.

Alternatively, only an outline of areas described in a particular vocabulary may be displayed. For example, a group of vocabularies to be displayed in outline view may be set. An outline of a document may be displayed such that only those areas described in a vocabulary included in the group are displayed in outline view. In this way, the structure of a document can be displayed in an easy-to-understand manner according to the elements or attributes of a vocabulary in focus.

Described above is an explanation of an embodiment of the present invention. The embodiment is intended to be illustrative only and it will be obvious to those skilled in the art that various modifications to constituting elements and processes could be developed and that such modifications are also within the scope of the present invention.

In the embodiment, an example of processing an XML document is discussed by way of example. Alternatively, the document processing apparatus 100 of the present invention is capable of processing documents described in other markup languages such as SGML and HTML.

### INDUSTRIAL USABILITY

The present invention is applicable to a document processing apparatus for processing a document described in a markup language.

1. A document processing apparatus comprising:
a document acquisition unit which acquires a document described in a markup language;
a setting unit which sets a condition for display of an outline of a document for each tag set of the markup language;
a memory unit which stores the condition for display; and
a creating unit which, when a request for displaying an outline of the document acquired by the document acquisition unit is accepted, reads from the memory unit the condition for display corresponding to a tag set included in the document, and creates a display of an outline of the document, based upon the condition.

2. The document processing apparatus according to claim 1, wherein
the condition for display includes a condition which specifies items to be displayed when displaying an outline of the document, and
the creating unit extracts the items to be displayed from the document and creates a display of an outline by hierarchizing the items in accordance with the hierarchy of the document.

3. The document processing apparatus according to claim 2, wherein
the condition for display further includes a condition which specifies an item to be used as a delimiter for the levels of the items to be displayed when displaying an outline of the document, and
the creating unit extracts the delimiter items from the document, and creates a display of an outline by hierarchizing the items to be displayed thus extracted, in accordance with the hierarchy of the delimiter items in the document.

4. The document processing apparatus according to claim 3, wherein
the creating unit creates a display of an outline by regarding those items to be displayed, located in the hierarchy between one delimiter item and another delimiter item at a lower level, as belonging to the same level.

5. The document processing apparatus according to claim 1, wherein
the condition for display includes a condition which specifies items to be displayed when displaying an outline of a document, and a condition which specifies a level of the items in the outline displayed, and
the creating unit extracts from the document the items to be displayed, and creates a display of an outline by identifying the levels of the items thus extracted in the outline displayed and hierarchizing the items in accordance with the levels thus identified.

6. A document processing method comprising:
acquiring a document described in a markup language;
setting a condition for display of an outline of a document for each tag set of the markup language;
storing the condition for display in a memory unit; and
reading, when a request for displaying an outline of the document thus acquired is accepted, from the memory unit the condition for display corresponding to a tag set included in the document, and creating a display of an outline of the document, based upon the condition.

7. A computer program product comprising:
a module which acquires a document described in a markup language;
a module which sets a condition for display of an outline of a document for each tag set of the markup language;
a module which stores the condition for display in a memory unit; and
a module which, when a request for displaying an outline of the document thus acquired is accepted, reads from the memory unit the condition for display corresponding to a tag set included in the document, and creates a display of an outline of the document, based upon the condition.
